(19) United States
(12) Patent Application Publication
(10) Pub. No.: US 2025/0300878 A1
(43) Pub. Date: Sep. 25, 2025

(54) COMMUNICATION SYSTEM, SERVER, AND COMMUNICATION METHOD

(71) Applicant: BROTHER KOGYO KABUSHIKI KAISHA, Nagoya (JP)

(72) Inventors: Tomofumi NAKAYAMA, Tokoname (JP); Yutaka TAKIJIRI, Nagoya (JP); Hiroki SUMI, Nagoya (JP)

(21) Appl. No.: 19/088,144

(22) Filed: Mar. 24, 2025

(30) Foreign Application Priority Data
Mar. 25, 2024 (JP) 2024-047938

(51) Int. Cl. H04L 41/0803; H04L 41/085

(52) U.S. Cl. CPC H04L 41/0803; H04L 41/085

(57) ABSTRACT

A server communicates with a first device and a second device and includes a controller configured to process setting requests. Upon receiving a setting request from the second device, which includes device identification information of the first device, setting information, and additional information, the server stores the additional information in a database separate from both devices. The server then transmits the setting information to the first device without including the additional information. The first device, upon receiving the setting information, transmits first data including device information and device identification information to the server. In response, the server retrieves the additional information associated with the device identification information from the database and transmits associated data, including the device information and the additional information, to the second device. This enables efficient data management while ensuring that additional information is not transmitted to the first device.

### REFERENCE TO RELATED APPLICATIONS

This application claims priority from Japanese Patent Application No. 2024-047938 filed on Mar. 25, 2024. The entire content of the priority application is incorporated herein by reference.

### BACKGROUND ART

The present disclosure relates to a communication system, servers of the communication system, and a communication method for the server.

There has been known technology in which a device, such as a printer, uploads device management information such as ink levels (i.e., the remaining ink amount) and number of prints (i.e., the number of sheets on which printing has been performed) to a server. In such technology, the device (e.g., the printer) typically receives destination designation information from a management server and stores the received destination designation information in a memory of itself (i.e., the device's memory). Then, the device identifies a destination to which the device management information is to be transmitted based on the destination designation information and uploads the device management information to the identified destination periodically or irregularly.

### SUMMARY

However, in such technology, there has been a possibility of problems such as increasing the amount of information to be stored in the device and leakage of stored information, such as unauthorized access to sensitive data, interception during communication, or data exposure due to device vulnerabilities, due to the fact that the destination designation information is stored in the device.

According to aspects of the present disclosure, there is provided a server that is configured to communicate with a first device and a second device. The server includes a controller provided with hardware that performs various operations. When the server receives a setting request from the second device, the request includes device identification information identifying the first device, setting information, and additional information. The server stores the additional information in a database in association with the device identification information. The database is separate from both the first device and the second device. The server then transmits the setting information to the first device identified by the device identification information but does not transmit the additional information.

Upon receiving the setting information, the first device transmits first data to the server, which includes device information and the device identification information. The server retrieves the additional information associated with the device identification information from the database. Finally, the server transmits associated data, which includes the device information and the additional information, to the second device.

According to aspects of the present disclosure, there is also provided a communication system. The communication system includes a first device, a second device, and a server configured to communicate with both devices. The second device transmits a setting request to the server, which specifies settings related to a service using the first device. The setting request includes device identification information identifying the first device, setting information, and additional information.

Upon receiving the setting request, the server stores the additional information in a database in association with the device identification information. The database is separate from both the first device and the second device. The server then transmits the setting information to the first device without including the additional information.

When the first device receives the setting information, it transmits first data to the server, including device information and the device identification information. The server retrieves the additional information associated with the device identification information from the database and transmits associated data, including the device information and the additional information, to the second device.

According to aspects of the present disclosure, there is further provided a communication method for a server configured to communicate with a first device and a second device. The method includes receiving a setting request from the second device, where the request includes device identification information identifying the first device, setting information, and additional information. Upon receiving the setting request, the server stores the additional information in a database in association with the device identification information. The database is separate from both the first device and the second device. The server then transmits the setting information to the first device without including the additional information.

Upon receiving the setting information, the first device transmits first data to the server, which includes device information and the device identification information. In response, the server retrieves the additional information associated with the device identification information from the database and transmits associated data, including the device information and the additional information, to the second device.

According to the above configuration, the additional information is not transmitted to the device (i.e., device A) but is transmitted to the external device (i.e., device B) along with the device information. As a result, the associated data containing both the device information and the additional information can be transmitted to the external device without the additional information being stored in the device (i.e., device A). This configuration prevents problems arising from storing additional information in the device, such as increased storage requirements or potential information leakage. For example, if the additional information includes sensitive data, leakage of the sensitive data can be effectively prevented. Sensitive data refers to data requiring protection from unauthorized access, such as data that could compromise privacy, security, or proprietary interests. According to aspects of the present disclosure, this configuration effectively prevents issues related to information storage in devices used for services.

### BRIEF DESCRIPTION OF DRAWINGS

FIG. 1 is a block diagram illustrating a configuration of a communication system.

FIG. 2 schematically shows a data structure of a database.

FIG. 3 is a sequence diagram illustrating a setting process.

FIGS. 4A and 4B show examples of a setting request.

FIG. 5 shows a first sequence diagram of a data transmission process.

FIG. 6A shows an example of identification data.

FIG. 6B shows an example of associated data.

FIG. 7 shows a second sequence diagram of the data transmission process.

FIG. 8 shows a sequence diagram illustrating a data obtaining process.

### DESCRIPTION

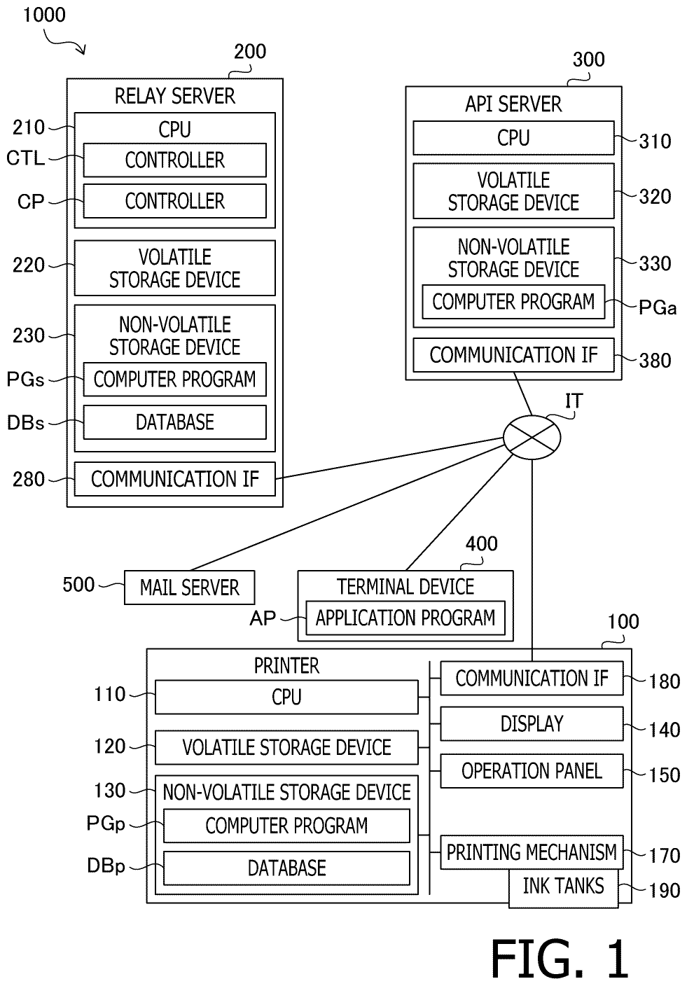

FIG. 1 is a block diagram showing a configuration of a communication system 1000 according to an embodiment of the present disclosure. The communication system 1000 includes a printer 100, a relay server 200, an API server 300, a terminal device 400 and a mail server 500.

The printer 100 is a device that consumes ink as a printing material to perform printing. As shown in FIG. 1, the printer 100 includes a CPU 110, a volatile storage device 120 such as a DRAM, and a non-volatile storage device such as a hard disk drive or a flash memory, which are part of or may constitute a controller of the printer 100. The printer 100 further includes a display 140 such as an LCD to display images/letters, an operation panel 150 provided with buttons and a touch panel to receive user operations, a printing mechanism 170 and a communication IF (interface) 180.

The communication IF 180 is an interface configured to connect the printer 100 to the Internet IT. The communication IF 180 is, for example, a wired interface compliant with Ethernet (a registered trademark of Xerox Corporation) or a wireless interface compliant with the Wi-Fi standard (a registered trademark of the Wi-Fi Alliance).

The CPU 110 is a processor configured to perform data processing. The volatile storage device 120 provides a buffer area configured to temporarily store intermediate data that is generated during processes performed by the CPU 110. The non-volatile storage device 130 is configured to store a computer program PGp to control the printer 100, and a database DBp configured to store various information, which will be described in detail later.

According to the present embodiment, the computer program PGp was initially stored in the non-volatile storage device 130 when the printer 100 was manufactured, and is retained therein. Alternatively, the computer program PGP may be provided, for example, in a form that can be downloaded from a server connected via the Internet IT, or in a form recorded on a storage medium such as a DVD-ROM, a USB memory stick, or the like.

By executing the computer program PGp, the CPU 110 performs various processes for controlling the printer 100. For example, the CPU 110 performs a printing process and a service-related process. The printing process is a process of controlling the printing mechanism 170 to print images. The service-related process is a process of providing services that utilize the printer 100. According to the present embodiment, the CPU 110 performs the service-related process in cooperation with the relay server 200 and the API server 300. The service-related process includes, for example, a process in which the printer 100 (i.e., the CPU 110) receives setting information from the relay server 200 and stores the received setting information as setting information for the printer 100 itself. The service-related process may also include a process in which the printer 100 (i.e., the CPU 110) transmits various types of information, such as history information indicating a print history, to the relay server 200 based on the stored setting information.

The database DBp stores various setting information, destination information (e.g., an IP address) to access the relay server 200, and authentication information. The setting information includes print-related setting information (e.g., setting information related to printing sheets, setting information related to print modes) and transmitted setting information that is transmitted from the relay server 200 for the service-related process mentioned above. In the following description, the term “setting information” refers to the information transmitted from the relay server 200 for the service-related process.

The printing mechanism 170 is configured to perform printing in accordance with the control of the CPU 110. In the present embodiment, the printing mechanism 170 is an inkjet printing mechanism. For example, the printing mechanism 170 uses multiple types of ink, such as cyan, magenta, yellow, and black, stored in ink tanks 190, to print images on a recording medium using an inkjet printing method. Alternatively, the printing mechanism 170 may be an electrophotographic printing mechanism that uses toner cartridges containing multiple color toners to print images.

Each of the relay server 200 and the API server 300 is, for example, a cloud server operated by a business operator that provides services using the printer 100 (e.g., a business operator that manufactures and/or sells the printer 100).

The relay server 200 includes a CPU 210 as a controller of the relay server 200, a volatile storage device 220 such as a DRAM, a non-volatile storage device 230 such as a hard disk drive or a flash memory, and a communication IF (interface) 280. The communication IF 280 is, for example, a wired interface compliant with Ethernet (a registered trademark of Xerox Corporation in the United States).

The CPU 210 is a processor configured to perform data processing. The volatile storage device 220 provides a buffer area configured to temporarily store various intermediate data that is generated during processes performed by the CPU 210. The non-volatile storage device 230 is configured to store a computer program PGs to control the printer 100 and database DBs configured to store various information.

The computer program PGP is provided, for example, by being uploaded by the business operator managing the service that uses the printer 100. The CPU 210 of the relay server 200 functions as both a controller CP for the relay server 200 and a controller CTL for the database DBs. The controller CP is configured to perform processes related to services using the printer 100. The relay server 200 is configured to relay communication between the printer 100 and the API server 300. As described later, the database DBs stores information required for a relay process.

Similar to the relay server 200, the API server 300 includes a CPU 310 serving as a controller, a volatile storage device 320, a non-volatile storage device 330, and a communication interface 380. The volatile storage device 320 provides a buffer area configured to temporarily store various intermediate data generated during processes performed by the CPU 310. The non-volatile storage device 330 stores a computer program PGa.

The computer program PGa, like the computer program PGs, is uploaded by the business operator managing the service that uses the printer 100. By executing the computer program PGa, the CPU 310 of the API server 300 performs the functions of the API server 300. The API server 300 provides an API (Application Programming Interface) that allows external devices, such as the terminal device 400 and other servers (not shown), to access the relay server 200. This enables the external devices to use the service provided by the relay server 200, including the relay process described above, via the API server 300.

The terminal device 400 is a computer used by a user of the printer. Examples include personal computers, smartphones, and similar devices. The terminal device 400 is equipped with a CPU, a memory, a display (e.g., an LCD), an operation panel (e.g., a touch panel), and a communication interface (not shown).

The terminal device 400 has an application program AP installed. The application program AP enables the CPU of the terminal device 400 to provide a service for using the printer 100. In this description, when the application program AP installed on the terminal device 400 is executed by the CPU to perform specific processes, the description may be simplified to state that “the terminal application” performs such processes. For example, the terminal application manages information about the printer 100 used by the user, such as print history and the remaining amount of printing materials (e.g., ink), and provides a service to display and notify the user of this information. The service provided by the terminal application is one of the services that use the printer 100.

The mail server 500 is a well-known server configured to relay email transmission and reception between client devices. For example, when the mail server 500 receives an email with a destination address from the API server 300, the mail server 500 forwards the email to the specified destination, such as the terminal device 400, via another mail server.

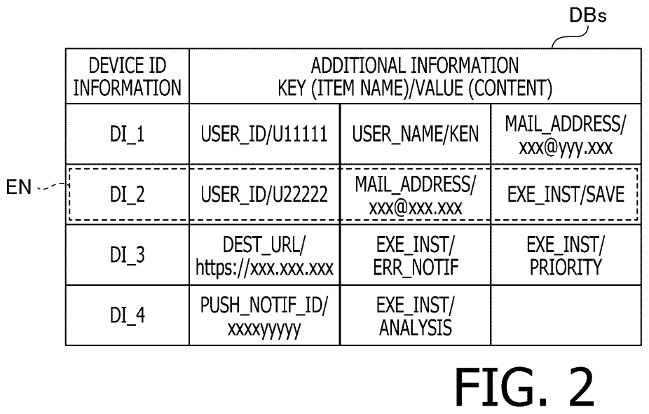

FIG. 2 illustrates an example configuration of the database DBs. As shown in FIG. 2, the database DBs stores one or more pieces of additional information in association with device ID information.

The device ID information is a unique identifier assigned to each device, such as the printer 100. The device ID information enables identification of a single device and may include, for example, a serial number or a device token. The device token serves as authentication information assigned to each device.

Each piece of additional information is configured by a key and a value, which are collectively referred to as an information pair. In the present disclosure, an information pair is represented in a format where the key and value that constitute the information pair are separated by a slash “/”. In the present embodiment, the key represents the name of the additional information (i.e., an item name), and the value represents the specific content of the additional information. For example, an information pair consists of a key “USER_ID”, which represents the item name “user identification”, and a value “U1111”, which represents the content of the item. This information pair is expressed as “USER_ID/U1111”.

In the example shown in FIG. 2, three pieces of additional information, namely “USER_ID/U1111”, “USER_NAME/KEN”, and “MAIL_ADDRESS/xxx@xxx.xxx” (where “MAIL ADDRESS” stands for “destination Mail Address), are stored in association with the device ID information “DI_1”. Similarly, three pieces of additional information, namely “USER ID/U2222”, “MAIL_ADDRESS/xxx@xxx.xxx”, and “EXE_INST/STORE” (where “EXE_INST” stands for “Execution Instruction”), are stored in association with the device ID information “DI_2”. Furthermore, three pieces of additional information, namely “DEST_URL/https://xxx.xxx.xxx” (where “DEST_URL” stands for “destination URL”), “EXE_INST/ERR ALERT” (where “ERR_ALERT” stands for “Error Alert”), and “EXE_INST/PRIORITY”, are stored in association with the device ID information “DI_3”. Additionally, two pieces of additional information, namely “PUSH_NOTIF_ID/xxxxyyyy” (where “PUSH_NOTIF_ID” stands for “Push Notification ID”) and “EXE_INST/ANALYSIS”, are stored in association with the device ID information “DI 4”.

The printer 100, the relay server 200, the API server 300, the terminal device 400, and the mail server 500 are connected to the Internet IT through their respective communication interfaces. Accordingly, for example, the relay server 200 communicates with the printer 100 and the API server 300 via the Internet IT. Similarly, the API server 300 communicates with the mail server 500 and the terminal device 400 via the Internet IT.

An operation of the communication system 1000, including the relay process performed by the relay server 200, will be described. The relay process includes a process in which the relay server 200 relays the setting information transmitted from the API server 300 to the printer 100. The relay process also includes a process in which the relay server 200 relays regular data transmitted from the printer 100 to the API server 300. In the present embodiment, the regular data includes, for example, operational status and status information periodically transmitted by the printer 100.

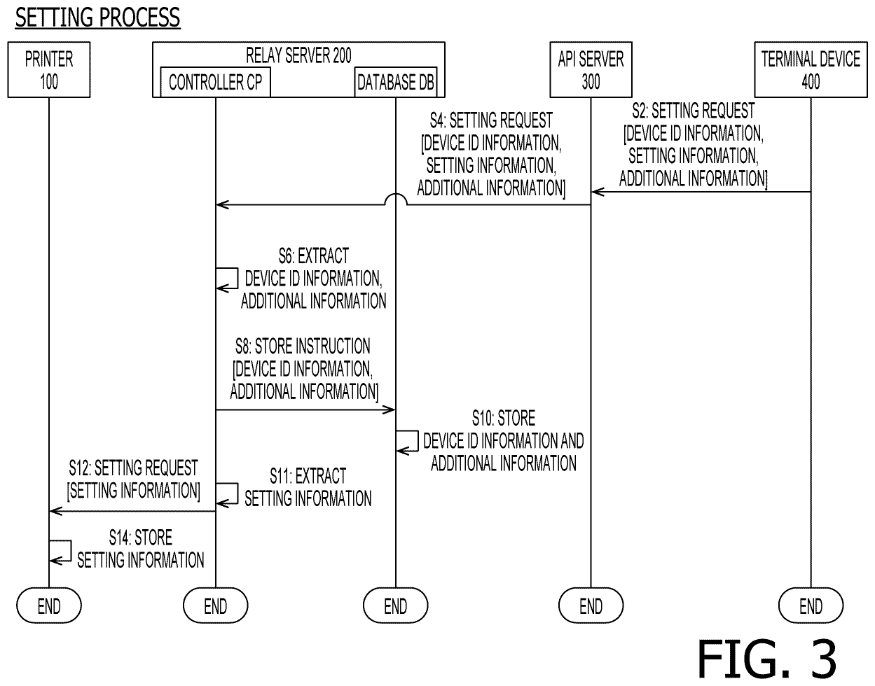

FIG. 3 is a sequence diagram illustrating a setting process performed by the communication system 1000. In the setting process, the setting information is stored in the printer 100 based on a setting request transmitted from the terminal device 400. For example, a user launches a terminal application on the terminal device 400 and inputs a management instruction into the terminal application to manage the operation history of the printer 100 (e.g., printing history or ink level history). When the terminal device 400 (i.e., the terminal application) receives the user's management instruction, the terminal device 400 initiates the setting process shown in FIG. 3. The elements in the brackets [] in FIG. 3 indicate the data transmitted in the communication represented by the arrows.

In S2, the terminal device 400 (i.e., the terminal application) transmits a setting request SR1 to the API server 300. The communication between the terminal device 400 and the API server 300 is performed in accordance with a well-known protocol, such as HTTP (Hypertext Transfer Protocol). The setting request SR1 is data used to request to perform a setting on a device (e.g., the printer 100) for a service that utilizes the device (i.e., the printer 100). It should be noted that the term “to perform a setting” refers to storing the setting information in the database DBp of the printer 100 and making the settings effective as indicated by the stored information.

When the API server 300 receives the setting request SR1, the CPU 310 of the API server 300 transmits the received setting request SRI without modification to the relay server 200 in S4. Communication between the API server 300 and the relay server 200 is conducted using a well-known protocol, such as HTTP, in the same manner as the communication between the terminal device 400 and the API server 300.

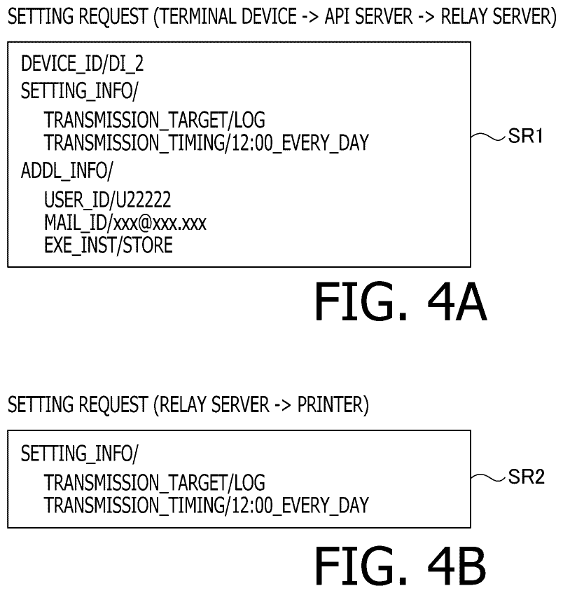

FIGS. 4A and 4B illustrate examples of the setting request SR1. The setting request SR1 illustrated in FIG. 4A includes device ID information, setting information, and additional information. As illustrated in FIGS. 4A and 4B, the device identification (ID) information, the setting information, and the additional information are each represented in the format of key-value pairs, specifically in the form of “key/value”, where the key and the value are separated by a forward slash (“/”).

The device ID information indicates a device to which the setting information contained in the setting request SR1 (i.e., the printer 100, in this embodiment) is to be transmitted. In other words, the device ID information indicates the destination to which the setting information is to be transmitted. In the example shown in FIG. 4A, the setting request SR1 contains the device ID information “DEVICE_ID/DI_2” which specifies the identification information “DI_2” of the printer 100 (where “DEVICE_ID” represents the “Device Identification information”). The device ID information may be obtained from the printer 100 in advance through the communication between the terminal device 400 and the printer 100, or input by the user.

The setting information indicates settings related to a service that uses the printer 100. For example, a terminal application needs to collect information from the printer 100 in order to provide the service. In this context, the setting information refers to information for causing the printer 100 to transmit log information used for the service. For instance, the setting information includes information indicating a transmission target (i.e., data to be transmitted) and information indicating transmission timing.

The transmission target specifies the content of information to be transmitted by the printer 100. Information designated as the transmission target may include log information that indicates the usage history of the printer 100. The log information may further include printing history, error or failure occurrence history, and ink level history. The transmission target may also include other types of information, such as print setting information, network setting information, and current ink level information. Additionally, the transmission target may consist of only a portion of the aforementioned log information. For example, the transmission target may include only one of the printing history, the log information, or the ink level history.

The transmission timing defines multiple points in time at which the printer 100 transmits the transmission target information. The transmission timing may be specified based on a transmission frequency, such as once a month or once a day, and specific transmission times. Alternatively, the transmission timing may be defined by transmission intervals, which can range from several seconds to several days. Furthermore, the transmission timing can be defined by specific actions, such as powering on the printer 100, the occurrence of a specific error, or performing operations like a printing process.

The setting information may include default information pre-implemented in the application program AP or information input by a user.

In the example shown in FIG. 4A, the setting request SR1 includes, as setting information, an information pair indicating log information as the transmission target and another information pair indicating “12:00 every day” as the transmission timing. Specifically, the value of the information pair keyed to “setting information” includes two information pairs: “TRANSMISSION_TARGET/LOG” and “TRANSMISSION_TIMING/12:00_EVERY_DAY”. As above, the value of an information pair can have a nested structure that includes one or more other information pairs.

In the present embodiment, the terminal application executes a service that provides the user with the usage history of the printer 100. Therefore, in the example shown in FIG. 4A, log information is specified as the transmission target. Further, the transmission timing is specified such that the information should be transmitted once a day at 12:00.

In the example shown in FIG. 4A, the setting request SR1 includes, as additional information, a user ID, a mail address, and execution information (i.e., information on an execution instruction). Accordingly, as shown in FIG. 4A, the value of the information pair keyed to “ADDL_INFO” (which represents additional information) includes three information pairs: “USER_ID/U22222”, “MAIL_ADDRESS/xxx@xxx.xxx”, and “EXE_INST/STORE”.

The additional information may include any type of data. As described later, the additional information is not transmitted to the device designated as the destination by the setting information. Instead, the additional information, as described below, is transmitted to the API server 300 or a destination of the identifying data, together with the identifying data (details will be described later) that is transmitted from a device such as the printer 100 based on the setting information. For this purpose, the additional information may include, for example, information that should be referenced by the API server 300 or the destination of the identifying data. Similar to the setting information, the additional information may include default information pre-implemented in the application program AP or information entered by the user.

Concretely, the additional information may include destination information that indicates the destination to which the identifying data is to be transmitted. The destination information may include, for example, an email address indicating the destination (also referred to as a destination mail address), a Uniform Resource Locator (URL) indicating the location of the destination (also referred to as a destination URL), an IP address indicating the destination (also referred to as a destination IP address), or push notification information indicating the destination for push notifications (also referred to as a push notification ID).

The additional information may include the execution instruction that specifies a process to be executed by the API server 300 or an external device that receives the identifying data. The value of the execution instruction may include, for example, “STORE”, “ANALYSIS”, “ERROR_NOTIFI” (error notification), or “PRIORITIZATION”.

The instruction to store directs an external device, which is the destination of the identifying data, to store the identifying data. The instruction to analyze directs the external device to perform a specific analysis using the identifying data. The analysis may involve, for example, a predefined analysis, such as predicting future print volumes or ink consumption based on printing history information included in the identifying data. Alternatively, the additional information may specify the detailed content of the analysis.

The instruction for error notification directs the extraction of error-related information and its transmission to a particular notification destination when the history information included in the identifying data indicates an error. The information indicating the particular notification destination may be included in the additional information.

The instruction for prioritization is an instruction that specifies a process using identifying data containing the prioritization instruction should be executed before a process using other identifying data that does not contain the prioritization instruction. For example, identifying data periodically transmitted from the printer 100 is typically processed sequentially in the order of reception by an external device that is the destination of the identifying data. However, identifying data containing the prioritization instruction is given priority over other identifying data, even if the other identifying data was received earlier and remains unprocessed. Thus, the prioritization instruction is a type of instruction that specifies the processing order for operations using identifying data.

The execution instruction may include various other types of instructions. For example, the execution instruction may include an instruction to generate a graph showing trends in print volume or ink consumption based on log information. Additionally, the execution instruction may include an instruction to automatically order ink when the ink consumption falls below a predefined threshold.

The additional information is not limited to the destination information or execution instructions and may include other types of information related to the service that uses the printer 100. For example, the additional information may include user information, such as a user ID or user name, identifying a user of the service.

In the present embodiment, data containing information pairs, such as the setting request SR1 including keys and values, is described using a well-known data format called JSON (JavaScript Object Notation). It should be noted that data containing information pairs is not necessarily limited to JSON and may also be described using markup languages such as XML (Extensible Markup Language) or HTML (HyperText Markup Language).

Returning to FIG. 3, when the relay server 200 receives the setting request SR1, the controller CP (i.e., CPU 210) of the relay server 200 extracts, in S6, the device ID information and additional information included in the setting request SR1. In S8, the controller CP transfers the extracted device ID information and additional information to the database DBs along with a storage instruction. Upon receiving the storage instruction, a controller CTL (i.e., CPU 210) of the database DBs stores the device ID information with the additional information in the database DBs in S10 in an associated manner. For example, when the setting request SRI shown in FIG. 4A is received in S4, an entry EN corresponding to one row, as indicated by dashed lines in FIG. 2 as an example, is created and stored in the database DBs.

In S11, the controller CP extracts the setting information from the setting request SR1 received in S4. In S12, the controller CP transmits a setting request SR2, which contains the extracted setting information, to the printer 100 via the communication interface 280.

In the present embodiment, the printer 100 establishes a persistent connection with the relay server 200 when the printer 100 is powered on. As a result, while the printer 100 remains powered on, the relay server 200 can proactively transmit data to the printer 100 through the persistent connection without receiving any requests from the printer 100. The persistent connection is established, for example, using a protocol called MQTT (Message Queuing Telemetry Transport). Alternatively, the persistent connection may be established using other protocols, such as XMPP (extensible Messaging and Presence Protocol).

For example, when the persistent connection is established, the relay server 200 receives device ID information from the printer 100 and manages the persistent connection in association with the device ID information. The controller CP uses the persistent connection associated with the device ID information included in the setting request SR1 received in S4 to transmit the setting request SR2. As a result, the setting request SR2 is transmitted to the printer 100, which is the device identified by the device ID information.

FIG. 4B illustrates an example setting request SR2 that is transmitted to the printer 100. The setting request SR2 contains only the setting information from the information included in the setting request SRI shown in FIG. 4A. In other words, the setting request SR2 does not contain the additional information or the device ID information.

When the printer 100 receives the setting request SR2, the printer 100 (CPU 110) stores the setting information included in the setting request SR2 in the database DBp as valid settings. As a result, the printer 100 is configured to transmit identifying data to the relay server 200 based on the setting information. In other words, the printer 100 is configured to transmit identifying data, which includes the information designated as the transmission target in the setting information, to the relay server 200 at the transmission timing specified in the setting information.

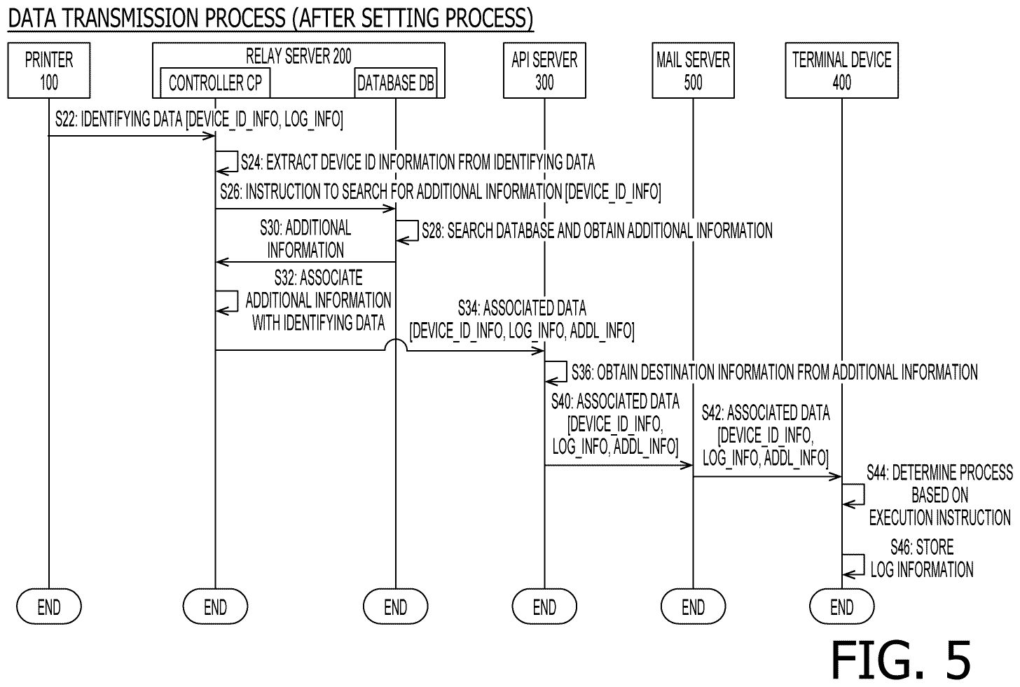

FIG. 5 is a first sequence diagram illustrating the data transmission process. This figure shows the data transmission process executed after the setting information is configured in the printer 100 through the aforementioned setting process. The data transmission process is initiated when the printer 100 transmits identifying data to the relay server 200 based on the setting information and is executed by the communication system 1000. The elements in the brackets [] in FIG. 5 indicate the data transmitted in the communication represented by the arrows.

In S22, the printer 100 transmits the identifying data to the relay server 200 based on the setting information stored in the database DBp of the printer 100. Here, it is assumed that the setting information included in the setting request SR2 shown in FIG. 4B has already been stored in the database DBp. In this case, the printer 100 transmits the identifying data to the relay server 200 at 12:00, which is the transmission timing specified in the setting information. As described above, while the printer 100 remains powered on, it maintains a persistent connection with the relay server 200. The identifying data is transmitted using this persistent connection.

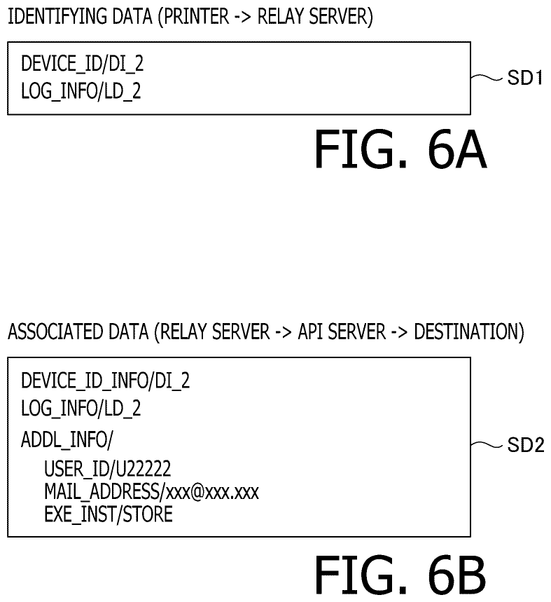

FIGS. 6A and 6B illustrate examples of identifying data and associated data (described later). The identifying data SD1 shown in FIG. 6A includes the identification information “DI_2” of the printer 100 and the log information “LD_2”, which is specified as the transmission target by the setting information. In other words, the identifying data SD1 in FIG. 6A includes two information pairs (key/value): “DEVICE_ID_INFO/DI_2” and “LOG_INFO/LD_2”. The printer 100 stores log information in its database DBp, which represents the operational history of the printer 100, and updates the log information each time an operation, such as printing, is performed. For example, the printer 100 identifies the portion of the log information that has not yet been transmitted to the relay server 200, includes that portion in the identifying data, and transmits the identifying data to the relay server 200.

When the relay server 200 receives the identifying data, the controller CP of the relay server 200 extracts the device ID information from the identifying data in S24. For example, when the identifying data SD1 shown in FIG. 6A is received, “DI_2” is extracted as the device ID information.

In S26, the controller CP passes the extracted device ID information to the database DBs and instructs the database DBs to retrieve the additional information associated with the device ID information.

When the controller CTL receives a retrieval instruction, the controller CTL searches the database DBs for the device ID information included in the retrieval instruction in S28. If an entry containing the device ID information is found, the controller CTL retrieves the additional information stored in the entry. In the example shown in FIG. 2, if the received device ID information is “DI_2”, the entry EN indicated by the dashed line is located. In this case, the additional information associated with the device ID information “DI_2”, namely “USER ID/U22222”, “MAIL ADDRESS/xxx@xxx.xxx”, and “EXE-INST/SAVE”, is retrieved.

In S30, the controller CTL transfers the retrieved additional information to the controller CP.

When the controller CP receives the additional information from the database DBs (i.e., from the controller CTL), the controller CP combines the additional information with the identifying data previously received from the printer 100 in S32 to generate the associated data SD2. FIG. 6B shows an example of the associated data SD2. In FIG. 6B, the associated data SD2 is data which includes the identifying data SD1 shown in FIG. 6A and three pieces of additional information: “USER_ID/U22222”, “MAIL_ADDRESS/xxx@xxx.xxx”, and “EXE-INST/SAVE”.

In S34, the controller CP transmits the generated associated data SD2 to the API server 300. As described above, in the present embodiment, the API server 300 is always the transmission destination for the identifying data received from the device by the controller CP.

When the API server 300 receives the associated data SD2, the CPU 310 of the API server 300 retrieves the destination information from the additional information included in the associated data SD2 in S36. In this embodiment, the destination information is one of the email address, the URL, the IP address, or the push notification ID, as described above. For instance, if the associated data SD2 shown in FIG. 6B is received, the destination information “MAIL ADDRESS/xxx@xxx.xxx” is retrieved, which, in this case, is the email address.

In S40, the API server 300 uses the retrieved destination information to transmit the associated data SD2 to the destination indicated by the destination information. For example, if the destination information is an email address, the API server 300 transmits the associated data SD2 to the mail server 500 in the form of an email addressed to the specified email address (see FIG. 5).

When the mail server 500 receives the associated data SD2 in the form of an email, the mail server 500 transmits the associated data SD2 to an external device based on the email address in S42. In this embodiment, the email address is an address that can be received by the terminal device 400 (terminal application). Consequently, the associated data SD2 is received by the terminal device 400, for example, via one or more other mail servers.

When the destination information is a URL or an IP address, for example, the API server 300 transmits the associated data SD2 to the destination specified by the URL or IP address using HTTP. As a result, the external device identified by the URL or IP address receives the associated data SD2. When the destination information is a push notification ID, for example, the API server 300 transmits the push notification ID and the associated data SD2 to a known push notification server (not shown). The push notification server then sends a push notification containing the associated data SD2 to the external device to which the push notification ID is assigned.

When the terminal device 400 receives the associated data SD2, the terminal device 400 (terminal application) determines the process to be executed in S44 based on the execution instruction included in the associated data SD2. For example, since the additional information in the associated data SD2 shown in FIG. 6B includes “EXE-INST/STORE”, the terminal device 400 determines that the process to be executed is “STORE” using the log information “LD_2”.

In S46, the terminal device 400 executes the process determined in S44. Specifically, in S46, the terminal device 400 stores the log information “LD_2” included in the associated data SD2 into a non-volatile storage device of the terminal device 400 (not shown).

The terminal device 400 (i.e., terminal application) can utilize the log information stored in the non-volatile storage device of the terminal device 400 for various purposes. For example, the terminal device 400 may use the log information to display the print history of the printer 100 on a display unit in response to a user instruction. Alternatively, the terminal device 400 may use the log information to notify the user about purchasing supplies, such as ink or paper, when the remaining quantity of supplies for the printer 100 falls below a predefined threshold.

The data transmission process executed after the setting information is configured in the printer 100 through the setting process has been described. However, the transmission of identifying data by a device, such as the printer 100, can also be performed even if the setting process is not executed. For example, if the user enables a log information update function on the printer 100, the printer 100 may transmit identifying data, including log information, based on the default setting information pre-stored in the printer 100.

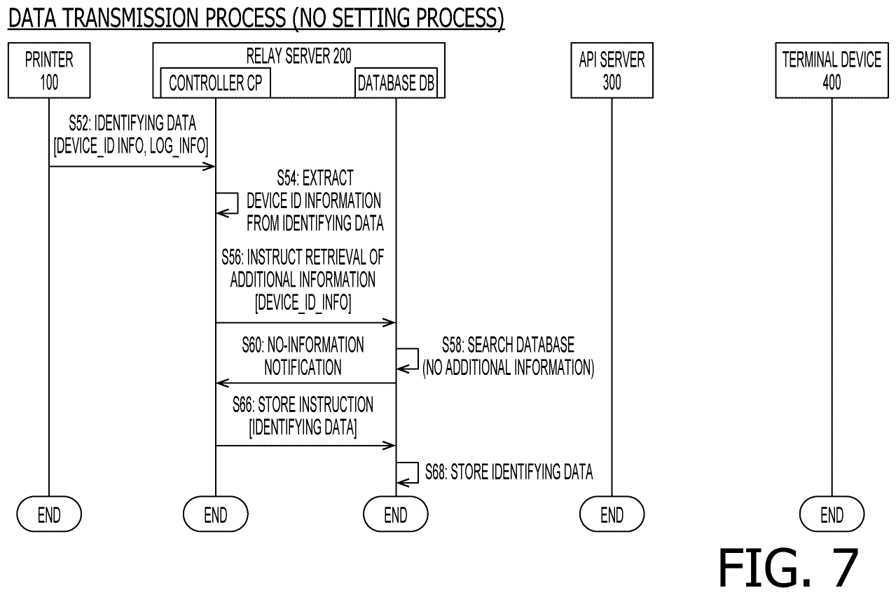

FIG. 7 is a second sequence diagram illustrating the data transmission process. FIG. 7 shows the data transmission process executed when the setting process is not performed. This data transmission process is initiated when the printer 100 transmits identifying data to the relay server 200 in accordance with the setting information pre-stored in the printer 100, and the data transmission process is carried out by the communication system 1000. The elements in the brackets [] in FIG. 7 indicate the data transmitted in the communication represented by the arrows.

In S52, the printer 100 transmits identifying data to the relay server 200 based on the default setting information. The identifying data transmitted is assumed to be the identifying data SD1 shown in FIG. 6A, as previously described. Similar to the process in S22 of FIG. 5, the identifying data is transmitted using the persistent connection established between the printer 100 and the relay server 200.

When the relay server 200 receives the identifying data SD1, the controller CP of the relay server 200 extracts the device ID information from the identifying data in S54, similar to the process in S24 of FIG. 5. If the identifying data SD1 shown in FIG. 6A is received, “DI_2” is extracted as the device ID information.

In S56, the controller CP passes the extracted device ID information to the database DBs and instructs the database DBs to search for additional information associated with the device ID information, similar to the process in S26 of FIG. 5.

When the controller CTL receives the search instruction, the controller CTL searches the database DBs for the device ID information provided with the search instruction in S58. As described above, the additional information is stored in the database DBs during the setting process shown in FIG. 3 (S10 in FIG. 3). Consequently, if the setting process shown in FIG. 3 is not executed, the search will not find any entry containing the received device ID information.

Therefore, in S60, the controller CTL passes a notification to the controller CP indicating that no additional information is stored in the database DBs (also referred to as a “no-information notification”).

When the controller CP receives the no-information notification from the database DBs, the controller CP instructs the database DBs to store the identifying data SD1 in S66. Upon receiving the storage instruction, the controller CTL stores the identifying data SD1 in the database DBs in S68. As described above, the identifying data SD1 includes the device ID information and the log information (FIG. 6A). Accordingly, storing the identifying data SD1 in the database DBs without separating its components means storing the device ID information and the log information in association with each other in the database DBs.

In the data transmission process shown in FIG. 7, the relay server 200 (controller CP) stores the identifying data SD1 in the database DBs without transmitting the identifying data SD1 to the API server 300. The reasons for this are as follows:

In the data transmission process shown in FIG. 3, the additional information associated with the identifying data SD1 includes destination information. In contrast, in the data transmission process shown in FIG. 7, no additional information exists. As a result, the relay server 200 cannot associate the identifying data SDI with destination information or transmit the identifying data SD1 to the API server 300. Therefore, even if the API server 300 receives the identifying data SD1, the API server 300 cannot recognize the destination of the identifying data SD1 and cannot transmit the identifying data SDI to an external device. Furthermore, the API server 300 does not have a function to temporarily store the identifying data SD1. For these reasons, in the data transmission process shown in FIG. 7, the identifying data SD1 is stored in the database DBs of the relay server 200.

As described above, in the data transmission process shown in FIG. 7, the identifying data SD1 transmitted from the printer 100 is stored in the database DBs of the relay server 200. The data obtaining process refers to a process in which the terminal device 400 retrieves the identifying data SD1 from the relay server 200 to utilize the log information included in the identifying data SD1.

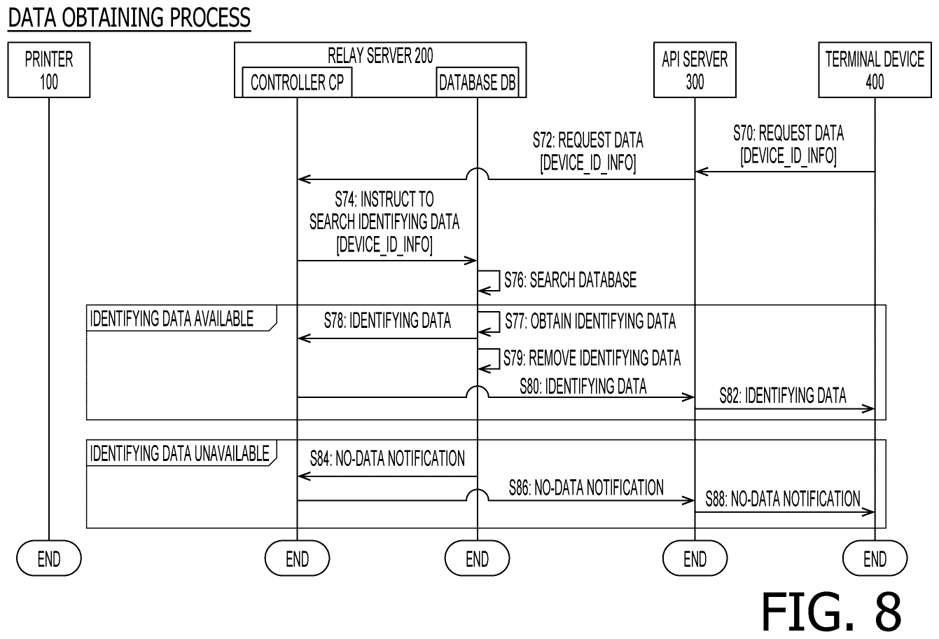

FIG. 8 is a sequence diagram illustrating the data obtaining process. This data obtaining process is triggered by the transmission of a data request from the terminal device 400 to the API server 300 and is executed by the communication system 1000. The elements in the brackets [] in FIG. 8 indicate the data transmitted in the communication represented by the arrows. The terminal device 400 transmits the data request periodically, for example, once a day or at predetermined intervals.

In S70, the terminal device 400 (terminal application) transmits a data request to the API server 300 to request identifying data. This data request includes the device ID information of the printer 100.

When the API server 300 receives the data request, the CPU 310 of the API server 300 transmits the received data request to the relay server 200 unchanged in S72.

When the relay server 200 receives the data request, the controller CP of the relay server 200 passes the device ID information included in the data request to the controller CTL in S74 and instructs the controller CTL to search for identifying data in the database DBs that contains the device ID information.

When the controller CTL receives the search instruction, the controller CTL searches the database DBs in S76 for identifying data that contains the device ID information provided with the search instruction. If identifying data containing the device ID information is found as a result of the search, steps S77 through S82 in FIG. 8 are executed.

In S77, the controller CTL retrieves the identifying data identified during the search from the database DBs. For example, the identifying data SD1 (FIG. 6A) stored in the database DBs in S68 of FIG. 7 is retrieved. In S78, the controller CTL transfers the retrieved identifying data SD1 to the controller CP. In S79, the controller CTL removes the identifying data SD1 from the database DBs.

When the controller CP receives the identifying data SD1 from the database DBs, the controller CP transmits the identifying data SD1 to the API server 300 in S80. The identifying data SD1 is sent to the API server 300 as a response to the data request in S72.

When the API server 300 receives the identifying data SD1, the CPU 310 of the API server 300 transmits the identifying data SD1 to the terminal device 400 in S82. The identifying data SD1 is transmitted to the terminal device 400 as a response to the data request in S70.

When the terminal device 400 receives the identifying data SD1, the terminal device 400 can utilize the log information included in the identifying data SD1 for various purposes. For example, similar to the case where the terminal device 400 receives the associated data SD2 in the data transmission process shown in FIG. 5, the terminal device 400 stores the log information in the non-volatile storage device of the terminal device 400. The terminal device 400 may use the stored log information to provide the user with a printing history or to notify the user about purchasing supplies or other consumables.

If the search in S76 does not find identifying data containing the device ID information, steps S84 to S88 in FIG. 8 are executed.

In S84, the controller CTL provides a notification (also referred to as a “no-data notification”) to the controller CP, indicating that identifying data containing the received device ID information cannot be found.

When the controller CP receives a no-data notification from the database DBs, the controller CP transmits the no-data notification to the API server 300 in S86. The no-data notification is sent to the API server 300 as a response to the data request in S72.

When the CPU 310 of the API server 300 receives a no-data notification, the CPU 310 transmits the no-data notification to the terminal device 400 in S88. The no-data notification is sent to the terminal device 400 as a response to the data request in S70.

According to the present embodiment described above, in the setting process shown in FIG. 3, the relay server 200 receives a setting request SR1 for the printer 100 from the API server 300 (S4 in FIG. 3). Upon receiving the setting request SR1, the relay server 200 stores the additional information in the database DBp in association with the device ID information contained in the setting request SR1 (S8, S10 in FIG. 3). The relay server 200 then transmits the setting request SR2 (FIG. 4B) to the printer 100 (S12 in FIG. 3), which includes the setting information contained in the setting request SR1 but excludes any additional information. In other words, the relay server 200 transmits the setting information from the setting request SR1 to the printer 100 while omitting the additional information from the transmission.

Furthermore, in the data transmission process shown in FIG. 5, the relay server 200 receives the identifying data SD1 (FIG. 6A) transmitted from the printer 100 based on the setting information (S22 in FIG. 5). Upon receiving the identifying data SD1, the relay server 200 retrieves the additional information associated with the device ID information included in the identifying data SDI from the database DBs (S28 in FIG. 5). The relay server 200 then transmits the associated data SD2 (FIG. 6B), which includes the log information from the identifying data SD1 and the additional information retrieved from the database DBs, to the API server 300 (S34 in FIG. 5).

As described above, in the present embodiment, the printer 100 does not transmit the additional information directly. Instead, the associated data SD2, which includes both the log information and the additional information, is transmitted from the relay server 200 to the API server 300. Consequently, the associated data SD2, containing the log information sent from the printer 100 and the additional information, can be transmitted to external devices such as the API server 300 without storing the additional information in the printer 100.

This approach prevents issues that may arise from storing additional information in the printer 100. For example, if additional information were stored in the printer 100, it could increase the amount of stored data. Moreover, the additional information may include personal details, such as email addresses or user names. Storing such information in the printer 100 could create a risk of data leakage. In the present embodiment, these issues related to storing additional information in the printer 100 are effectively mitigated.

Furthermore, in the present embodiment, the additional information includes destination information that specifies the transmission destination of the identifying data SD1 (i.e., the log information), such as a destination email address or URL (FIGS. 2 and 4A). The API server 300, which receives the associated data SD2, uses the destination information to transmit the associated data SD2 to another device, such as the mail server 500. In other words, the API server 300 transmits the associated data SD2 to the destination specified by the destination information included in the associated data SD2.

As a result, the printer 100 does not need to store the destination for sending the log information. The printer 100 only needs to transmit the identifying data SD1, which includes the log information, to the relay server 200. The identifying data SD1 is then transmitted to the appropriate destination through the relay server 200 and the API server 300.

Further, in the present embodiment, the setting information includes information indicating the timing of multiple transmissions (transmission timing information) and information indicating the content of the information to be transmitted (transmission target information) (FIGS. 4A and 4B). As a result, the terminal device 400 can send a single setting request via the API server 300 to the relay server 200, enabling the printer 100 to transmit the identifying data SD1 multiple times. For example, in services that use the printer 100, it is often necessary to periodically collect information (e.g., log information or other historical information) from the printer 100. In such cases, the necessary settings for the printer 100 can be easily configured.

Furthermore, in the present embodiment, the additional information includes instruction information (execution instruction information) that specifies the processing to be executed using the information (e.g., log information) contained in the associated data SD2 transmitted from the API server 300 to the terminal device 400, which receives the associated data SD2 (FIG. 4A). As a result, the printer 100 does not need to include the instruction information in the identifying data SD1. In other words, even if the printer 100 does not store the instruction information, the terminal device 400 can receive information, such as log information, and execute the appropriate processing based on that information.

More concretely, the information included in the identifying data SD1 includes log information that shows the history of the operation of the printer 100. As a result, for example, the terminal device 400 (terminal application) can provide a service that uses the history of the operation of the printer 100 by collecting the log information of the printer 100. Further, the execution instruction information includes information indicating at least one of the following instructions: a save instruction to save the log information as described above; an error notification instruction to notify when the log information indicates an error; an analysis instruction to perform specific analysis using the log information; and an instruction to specify the order of processing using the log information (e.g., a priority instruction) (FIG. 2). As a result, even if the printer 100 does not store the instruction information, it is possible to have the terminal device 400, which receives the associated data SD2 including the log information, appropriately perform the processes that use the printer 100's log information, such as saving, analyzing, and notifying errors. Furthermore, it is possible to have the terminal device 400 execute the processes that use the log information in the appropriate order.

Furthermore, according to the present embodiment, as explained with reference to FIG. 7, the printer 100 can transmit the identifying data SDI without receiving the setting information from the relay server 200. In this case, the relay server 200 receives the identifying data SD1 from the printer 100 without receiving the setting information (S52 in FIG. 7) and stores it directly in the database DBs (S68 in FIG. 7). In other words, the log information is stored in the database DBs in association with the device ID information contained in the identifying data SD1.

Then, as explained with reference to FIG. 8, the relay server 200 receives a data request from the API server 300 after the log information is stored in the database DBs (S72 in FIG. 8). Upon receiving the data request, the relay server 200 transmits the identifying data SD1, which includes the log information, to the API server 300 (S82 in FIG. 8). As a result, even if the setting process is not performed, the identifying data SD1 transmitted from the printer 100 can be sent to the API server 300 in response to a request from the API server 300. For instance, even if the setting process is not performed, when the printer 100 uploads the identifying data SD1 containing the log information to the relay server 200, the terminal device 400 can obtain the log information of the printer 100 by sending a data request to the relay server 200 via the API server 300.

As can be understood from the above description, the printer 100 in the present embodiment is an example of a device A, and the API server 300 is an example of a device B in accordance with aspects of the present disclosure. Further, the relay server 200 is an example of a server according to aspects of the present disclosure. Further, the identifying data SD1 is an example of first data and second data. Specifically, the identifying data SDI transmitted in S22 is an example of the first data, and the identifying data SD1 transmitted in S52 is an example of the second data according to aspects of the present disclosure. Specifically, the identifying data SD1 which is transmitted when the setting process has been performed is an example of the first data and the identifying data SD1 when the setting process is not performed is an example of the second data according to aspects of the present disclosure. Furthermore, the log information is an example of device information, and the associated data SD2 is an example of transmission data.

While aspects of the present disclosure have been described with reference to various example structures outlined above and illustrated in the figures, numerous alternatives, modifications, variations, improvements, and substantial equivalents, whether currently known or unforeseen, may be apparent to those of ordinary skill in the art. Accordingly, the example embodiments set forth above are intended to illustrate the present disclosure and not to limit its scope. Various changes may be implemented without departing from the spirit and scope of the disclosure. Therefore, the disclosure is intended to encompass all known or future alternatives, modifications, variations, improvements, and substantial equivalents. Specific examples of potential alternatives, modifications, or variations in the described embodiments are provided below.
(1) In the above embodiment, the external device that communicates directly with the relay server 200 is the API server 300 (FIG. 1). Alternatively, the terminal device 400 may be configured to communicate directly with the relay server 200 without going through the API server 300. In such a case, the API server 300 may be omitted. In such a case, in the setting process of FIG. 3, the terminal device 400 may be configured to transmit a setting request to the relay server 200 without going through the API server 300 at S2. Then, in the data transmission process shown in FIG. 5, the relay server 200 obtains the destination information from the additional information at S34, and transmits the associated data SD2 to the destination indicated by the destination information using the obtained destination information. In other words, the relay server 200 executes the processes performed by the API server 300 at S36 and S40 in FIG. 5 on behalf of the API server 300.

Incidentally, according to this modification, in the setting process shown in FIG. 3, the external device from which the setting request is received by the relay server 200 is the terminal device 400, and in the data transmission process shown in FIG. 5, the external device to which the relay server 200 transmits the associated data SD2 is the mail server 500. In other words, in the embodiment, the external device that directly communicates with the relay server 200 is the same device (the API server 300) as the external device that sends the setting request and the external device that receives the associated data SD2. In contrast, in the modification, a first external device (the terminal device 400) that sends the setting request and a second external device (the mail server 500) that receives the associated data SD2 are different devices.

In this modification, since the relay server 200 transmits the associated data SD2 to the destination specified in the destination information contained in the additional information, there is little need to include the destination information in the associated data SD2. For this reason, the associated data SD2 may include only the information (e.g., the execution instructions and user ID in FIG. 2) from the additional information that excludes the destination information, or it may include all the additional information, including the destination information, as in the embodiment. Even if the associated data SD2 contains unnecessary destination information, if the device that receives the associated data SD2 is the destination indicated by the destination information, it is thought that there will be no problem if the specification is such that the associated data SD2 is not transferred.
(2) In the embodiment described above, the execution instructions contained in the additional information are instructions for a device (e.g., the terminal device 400) that receives the associated data SD2 via the API server 300. Not limited to this, all or part of the execution instructions contained in the additional information may also include instructions for the API server 300. The execution instructions for the API server 300 may include instructions to return the associated data SD2 to the relay server 200, for example, when transmission to the destination of the associated data SD2 (S40 in FIG. 5) fails.

Incidentally, if the additional information includes both the execution instruction for the API server 300 and the execution instruction for the terminal device 400 (i.e., the terminal application), the additional information may also include information specifying the device or application to be the target of the execution instruction.
(3) In the above embodiment, the device that uses the relay server 200 via the API server 300 is the user's terminal device 400, but the device is not limited to the terminal device 400. For example, a server that provides a service using the printer 100 to the user of the printer 100 may use the relay server 200 via the API server 300.

As an example, a cased where a print management server that provides metered printing services uses relay server 200 is described. For example, the print management server generates configuration information that sets each printer to be managed to send information on the remaining ink and the number of pages printed each time printing is executed. The print management server transmits a setting request to the relay server 200 via the API server 300, including the configuration information, additional information that includes the destination URL indicating the URL of the print management server itself, and device ID information for the printer to be managed. This setting request is transmitted at S2 and S4 in FIG. 3 in the same way as the terminal device 400. This causes the setting process in FIG. 3 to be executed, and the setting information is set in the printer 100.

In this way, each time printing is executed on the printer 100, identifying data including ink remaining quantity information and the number of printed pages is transmitted from the printer 100 to the relay server 200. When the identifying data is transmitted from the printer 100 to the relay server 200, the data transmission process in FIG. 5 is executed, and the associated data including the ink remaining amount information and the number of prints is transmitted to the print management server via the relay server 200 and the API server 300. As a result, the print management server can manage the ink remaining amount information and the number of prints for the printer 100. For example, if the ink remaining in the printer 100 falls below a certain level, the print management server executes a process to send ink for refilling to the user of the printer 100. For example, the print management server executes a process to charge the user of the printer 100 by totaling the number of prints made by the printer 100 each month. In this way, the print management server can provide a printing service using the printer 100.

For example, the print management server can also transmit the log information of the printer 100 to other servers by setting the destination information included in the setting request to the URL of another server. For example, the destination of the ink remaining amount information can be set to the shipping server that executes the ink shipping process, and the destination of the number of printed pages can be set to the billing server that executes the billing process for printing.
(4) In the above embodiment, it is assumed that the additional information includes the destination information. Alternatively, the additional information may not include the destination information. In such a case, for example, in the data generation process of FIG. 5, when the controller CP of the relay server 200 receives the additional information from the database DBs at S30, it determines whether the additional information includes the destination information or not. If the controller CP receives destination information in the additional information, it combines the additional information with the specified data to generate associated data, as shown in S32 and S34 of FIG. 5, and transmits the associated data to the API server 300. If the controller CP does not receive destination information in the additional information, it instructs the database DBs to store the specified data, as shown in S66 and S68 of FIG. 7, and stores the specified data in the database DBs. If the additional information does not include the destination information, the API server 300 cannot transmit the associated data SD2, so the terminal device 400 receives the identifying data using the data obtaining process in FIG. 8.
(5) The setting request in FIG. 4A is only one example and is not limited to this. For example, the setting information contained in the setting request includes information on the information to be transmitted and information on the timing of transmission, but it is also possible to include only one of the information on the information to be transmitted and the information on the timing of transmission. In such a case, the other of the information on the information to be transmitted and the information on the timing of transmission may be set to the default setting in the printer 100. In addition, the configuration information may also include configuration information for other settings. For example, the configuration information may include settings for performing various operations, such as turning on the power once a day and connecting to the network.
(6) In the above embodiment, the printer 100 is used as the device used for the service, but other types of devices may be used. The device may be a scanner or digital camera that generates image data by optically reading an object using an image sensor, for example. The device may be a sewing machine that forms an image such as a pattern on a piece of cloth by embroidering it with thread, for example, or a terminal device such as a smartphone or personal computer.

Further, the device is not limited to image processing devices such as printers, scanners, cameras, and sewing machines, and various devices that can be connected to the Internet IT can be adopted. For example, the device can be a device unrelated to images, such as a home appliance such as a refrigerator or microwave oven, or it can be a music player or temperature sensor.

The contents of the setting information, such as the contents of the transmission target and transmission timing, will be changed as appropriate depending on the type of device used and the nature of the service. Further, the contents of the additional information will also be changed as appropriate depending on the type of device used and the nature of the service. In general, services that use devices can be implemented by, for example, storing setting information on the device, and services that can be implemented by collecting information about the device from the device by storing setting information on the device.
(7) In the above embodiments, some of the hardware-based components may be replaced with software, and conversely, some or all of the software-based components may be replaced with hardware.
(8) In the above embodiment, the database DBs is provided within the relay server 200. However, the database DBs may be located anywhere as long as it is not within the terminal device 400 or the printer 100.

As described above, the present disclosure has been explained based on the embodiments and modifications. However, the embodiments of the disclosure described above are provided to facilitate understanding of the aspects of the present disclosure and do not limit its scope.

The aspects of the present disclosure may be modified and improved without departing from its spirit and the scope of the claims and include equivalents thereof.

What is claimed is:

1. A server configured to communicate with a first device and a second device, the server comprising a controller provided with hardware and configured to perform:
receiving a setting request from the second device, the setting request including device identification information identifying the first device, setting information, and additional information;
storing, in response to receiving the setting request, the additional information in a database in association with the device identification information included in the setting request, the database being separate from both the first device and the second device; and
transmitting, in response to receiving the setting request, the setting information to the first device identified by the device identification information included in the setting request, without transmitting the additional information included in the setting request;
receiving, from the first device, first data including device information transmitted based on the setting information and the device identification information; and
obtaining, in response to receiving the first data, the additional information stored in the database in association with the device identification information included in the first data from the database; and
transmitting, in response to receiving the first data, associated data including the device information included in the first data and the additional information obtained from the database to the second device.

2. The server according to claim 1,
wherein the database is stored within the server.

3. The server according to claim 1,
wherein the additional information includes destination information indicating a destination to which the device information is to be transmitted, and
wherein the destination information is used by the second device, which receives the associated data, to transmit the device information included in the associated data to another device.

4. The server according to claim 1,
wherein the setting information includes information indicating timing for executing multiple transmission of the device information and information indicating contents of the device information to be transmitted in the multiple transmissions.

5. The server according to claim 1,
wherein the additional information contains instruction information that includes an instruction to perform a process, using the device information, to be executed by one of the second device or a communication device configured to receive the device information transmitted by the second device.

6. The server according to claim 5,
wherein the device information includes history information indicating an operation history of the first device; and
wherein the instruction information indicates at least one of the following:
a storage instruction to store the history information;
a notification instruction to provide a notification when the history information indicates a particular operation of the first device;
an analysis instruction to perform a particular analysis process using the history information; or
an order designation instruction to designate an order of processes using the history information.

7. The server according to claim 1,
wherein the receiving receives second data including the device information and the device identification information from the first device, the second data being transmitted from the first device without the first device receiving the setting information;
wherein, in response to the receiving the second data, the storing stores the device information in the database in association with the device identification information included in the second data;
wherein the receiving receives a request for the device information from the second device after the device information is stored in the database; and
wherein the transmitting transmits the device information to the second device in response to the receiving the request for the device information.

8. The server according to claim 1,
wherein the second device includes a first external device and a second external device;
wherein the receiving receives the setting request from the first external device; and
wherein the transmitting transmits the associated data to the second external device.

9. The server according to claim 1,
wherein the additional information includes sensitive data to be protected from leakage.

10. A communication system comprising a first device, a second device, and a server configured to communicatively connected to the first device and the second device,
wherein the second device is configured to transmit a setting request to the server, the setting request indicating settings related to a service using the first device, the setting request including device identification information identifying the first device; setting information; and additional information,
wherein the server is configured to perform:
storing, in response to receiving the setting request, the additional information in a database in association with the device identification information included in the setting request, the database being separate from both the first device and the second device; and
transmitting, in response to receiving the setting request, the setting information included in the setting request to the first device identified by the device identification information, while not transmitting the additional information included in the setting request to the first device,
wherein the first device is configured to perform:
transmitting, in response to receiving the setting information, first data including device information and the device identification information to the server based on the setting information, and
wherein the server is configured to perform:
obtaining, in response to receiving the first data, the additional information from the database in association with the device identification data included in the first data; and
transmitting, in response to receiving the first data, associated data including the device identification information included in the first data and the additional information obtained from the database to the second device.

11. The communication system according to claim 10,
wherein the additional information includes destination information indicating a destination to which the device information is to be transmitted; and
wherein the second device is configured to transmit, in response to receiving the associated data, the device information included in the associated data to the destination that is indicated by the destination information included in the associated data.

12. The communication system according to claim 10,
configured such that the additional information is not stored in the first device.

13. The communication system according to claim 12,
wherein the additional information includes sensitive data to be protected from leakage.

14. The communication system according to claim 10,
wherein the database is stored within the server.

15. A communication method for a server that is configured to communicate with a first device and a second device, the method comprising:
receiving a setting request from the second device, the setting request including device identification information identifying the first device, setting information, and additional information;
storing, in response to receiving the setting request, the additional information in a database in association with the device identification information included in the setting request, the database being separate from both the first device and the second device; and
transmitting, in response to receiving the setting request, the setting information to the first device identified by the device identification information included in the setting request, without transmitting the additional information included in the setting request;
receiving, from the first device, first data including device information transmitted based on the setting information and the device identification information; and
obtaining, in response to receiving the first data, the additional information stored in the database in association with the device identification information included in the first data from the database; and
transmitting, in response to receiving the first data, associated data including the device information included in the first data and the additional information obtained from the database to the second device.
